(19) United States
(12) Patent Application Publication
(10) Pub. No.: US 2008/0165408 A1
(43) Pub. Date: Jul. 10, 2008

(54) Method and Device For Modifying the Polarization State of Light

(76) Inventors: Hannelore Kopta-Didosyan, Vienna (AT); Karina Gloukhareva, Stockholm (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/792,316

(22) PCT Filed: Nov. 17, 2005
(86) PCT No.: PCT/AT2005/000463

§ 371 Date: Feb. 8, 2008

(30) Foreign Application Priority Data
Dec. 9, 2004 (AT) A 2074/2004

(51) Int. Cl. G02F 1/09

(52) U.S. Cl. 359/280

(57) ABSTRACT

A method for modifying the polarization state of light with a magnetically uniaxial crystal which initially has a specific multidomain structure, wherein light enters via predefined areas of the crystal, and wherein a magnetic field pulse having a magnetic intensity H1 is applied to the crystal (1), wherein the crystal (1) is transformed into a reversible monodomain state. In order to obtain an enlargement of the useful aperture, while at the same time keeping switching and response times to a minimum, a retention magnetic field of transition of the crystal (1) into a reversible monodomain state, wherein the magnetic field intensity H2 is lower than the magnetic field intensity H1 and the reversible monodomain state is maintained.

The invention relates to a method for modifying the polarization state of light with a magnetic uniaxial crystal which initially has a specific multidomain structure wherein light enters through predefined areas of the crystal, wherein a magnetic field pulse having a magnetic intensity H1 is applied to the crystal and wherein the crystal is transformed into a reversible monodomain state. It also relates to a device to carry out such a method comprising a magneto-optical rotator formed by a magnetic uniaxial crystal which has initially a specific multidomain structure and at least one device to produce magnetic field pulses and apply them to the crystal, and it comprises a controllable source for the magnetic field pulses and a control switch for the magnetic field source. Objects of the invention are thus methods and devices to modify the polarization of light beams which results in changing the direction, the intensity, and the like of said light beams as they are employed in optic communication systems, information processing, displays etc.

Microelectromechanical systems (MEMS) are currently used most often among numerous types of optic switches. An important advantage of MEMS is the fact that they belong to the so-called category of “latching systems”, which means, that they have nondissipative stable switching conditions whereby they need energy only for switching itself while electro-optic systems need a constant energy supply with relatively much shorter switching times—at least in one state. However, the switching times in these electro-optic systems are rather lengthy—approximately 1 millisecond.

With magneto-optic systems there is created the possibility to combine short switching times and low insertion loss with the so-called “latching” function (see above). A multi-stable polarization rotator is described in AT 408.700 B. Stable conditions are guaranteed in said rotator through inhomogeneities on the surfaces of orthoferritic wafers which maintain the domain walls (DW) in predefined positions. Transitions between these stable conditions develop through the movement of domain walls between these layers and they develop without the creation of new domains. The required time for these transitions is approximately 100 nanoseconds, which means that said transitions develop a few thousand times faster than for other optic switches of the “latching” type. However, the aperture of the switch is considerably reduced.

AT 411.852 discloses a method and a device to modify the polarization state of light with a magnetic uniaxial crystal wherein the crystal is provided initially with a specific multidomain structure which changes into a monodomain state under the influence of an exterior magnetic field in the direction of the domain orientation of the correspondingly applied magnetic field. A magnetic field pulse is applied thereby to the crystal having a magnetic field intensity in which the crystal does not remain in the monodomain state at the end of the pulse but whereby it returns to a defined multidomain state determined by the direction of the designed magnetic field, preferably in a state with three domains. The height of the outer domains of the yttrium orthoferrite of 1.2 mm in height measures 300 to 350 μm whereby they were used up to now for modifying the polarization state of light. However, larger apertures in the range of 500 to 600 μm are required in many areas, e.g. in fiber-optic applications. The aperture is thereby defined by the zone in which the polarity of magnetization is changed by the applied magnetic field pulses and whereby said pulses can be used thereby to influence the light passing through the crystal.

However, the use of higher orthoferrite crystals does not lead to the enlargement of the dimensions of domains, but it leads to the increase of the amount of domains within the crystal. The central domain would have the desired aperture already in a crystal of 1.2 mm in height. The use of such crystal was not possible up to now for the following disadvantages. The change of polarity of the central area of the crystal starts only after the end of the pulses and lasts a few microseconds while applying magnetic field pulses of alternating polarity for reversible magnetizing of the crystal to obtain a monodomain state. The change of polarity of the central domains starts nevertheless simultaneously with the start of the pulses while applying magnetic field pulses with the same polarity as in the outer domains; however, magnetization returns to its original value after said change.

The object of the present invention is the improvement of the aforementioned methods and devices with the idea of enlarging the usable aperture and obtaining the lowest switching and response times possible.

The method is characterized for the achievement of the object in that a retention magnetic field of the same polarity and having a magnetic field intensity H2 is applied to the crystal after transition of the crystal into a reversible monodomain state, wherein the magnetic intensity H2 is lower than the magnetic field intensity H1 and the reversible monodomain state is maintained. The changing of the central domain back into the initial magnetization can be prevented through rapid switching by the strong magnetic field pulse and this occurs with a considerably lower energy requirement as in other electro-optic systems, for example. A specific area of the crystal can thereby be utilized as aperture which corresponds in its multidomain state to the magnetized domains applied antiparallel to the applied magnetic field pulse, whereby said domains have the desired height of approximately 500 μm or possibly even more.

According to an advantageous embodiment of the invention it is proposed that the retention magnetic field H2 is adjusted by changing the magnetic field intensity of the previously applied magnetic field pulse. The magnetic field intensity can be varied in a simple manner through this variant. The design of the device can be kept very simple as well.

An alternative embodiment of the invention is characterized in that the crystal having a retention magnetic field of the magnetic field intensity H2 and the same polarity as the one with the magnetic field pulse is permanently biased with the magnetic field intensity H1. The switch to produce magnetic field pulses can be kept simpler with only slightly higher expenditures relative to the design of the device since principally only on and off-switching must be provided.

The magnetic field intensity H2 of the retention magnetic field is advantageously maximal one third of the magnetic field intensity H1 of the magnetic field pulse, preferably maximal 10 percent of said magnetic field intensity H1, which is required to reach the reversible monodomain state of the crystal. This ratio influences directly the energy savings compared to the electro-optic methods and devices.

An additional improvement can be reached relative to the switching times and it can be achieved with the method according to the invention in that at least at one area of the crystal—which has been reversibly changed in polarization—a magnetic field is applied with a polarity opposite to the reversible re-polarized magnetic field pulse until the initial polarization of the crystal has been re-established in this area. Re-polarization of the crystal back into the multidomain state is accelerated thereby at the end of the magnetic field pulse which causes the monodomain state in the crystal. This advantage can be achieved with relative low energy and mechanical requirements based on the purely local effect on the areas of the crystal which were changed back into the initial magnetic orientation and which corresponds to the re-polarized domain(s) of the multidomain state.

An additional advantageous embodiment example of the invention proposes that the domain walls are held in predetermined positions by inhomogeneities created in the crystal.

According to the characteristics of an additional variant of the invention, light beams are guided through areas in the crystal which are changed in polarization by applying the magnetic field pulse with the magnet field intensity H1. This area of the crystal is the central domain with a height of approximately 500 μm, which changes the magnetization, so that application possibilities of the inventive method and device can be expanded to the employment in fiber optics, for example.

The device described heretofore for modifying the polarization state of light is characterized in the invention for achievement of the stated object in that the device is designed for the creation of magnetic fields of at least two different magnetic field intensities H1 and H2. The device can thereby reach rapid switching times and obtain a large aperture for modifying the polarization state of light, which is caused by the change of magnetic polarization of the larger domain(s) of the crystal, mostly the central domains in the present case, by applying a strong magnetic field pulse. The reconverting of the crystal into the initial magnetization and the return of the crystal thereby into the multidomain state can be prevented by the retention magnetic field so that the larger domain(s) can be used for the transmission of light.

An advantageous embodiment of the device according to the invention is characterized in that the control switch of the controllable magnetic field source is provided with at least two switching conditions controlling the magnetic field source for the creation of magnetic fields or magnetic field pulses of different magnetic field intensities H1 and H2. A single magnetic coil surrounding the crystal can be provided as a controllable magnetic field source in a simple design of the device, whereby a control device for said magnetic field source can be realized in a simple manner as well.

The control device can be even simpler and can be limited to on- and off-switching of the controllable magnetic field sources if, according to an additional embodiment, the device to create and apply magnetic fields on the crystal is provided with a controllable magnetic field source having at least two switching conditions and a permanent magnetic field source, whereby the controllable magnetic source supplies in one switching condition a considerably higher magnetic field intensity H1 than the magnetic field intensity H2 of the permanent magnetic field source. The permanent magnetic field source can be realized in its most simple manner through a permanent magnet installed possibly on or next to the crystal.

An embodiment is proposed according to the invention to re-polarize the crystal into the multidomain state after the end of the magnetic field pulse and to improve also here the switching times whereby an additional controllable magnetic field source is provided effecting only one area of the crystal with a magnetic field or magnetic field pulses, whereby said area corresponds to the domains re-polarized by the magnetic field pulses of the first magnetic field source, and whereby the polarity of the additional controllable magnetic field source is opposite the polarity of the magnetic fields or pulses having magnetic field intensities H1 and H2. This advantage can be reached with relative low energy and mechanical requirements based on the purely local magnetic effect at the central area of the crystal, which consists mainly in the present initial condition of three magnetic domains, and whereby said central area corresponds to the domain(s) of alternating polarity.

According to an advantageous embodiment of the device it is proposed that the crystal is provided with inhomogeneities fixing the domains in predetermined positions and whereby said inhomogeneities are located preferably on the sides of the crystal.

Additional characteristics and advantages of the inventive method and the corresponding device are described in more detail in the following description as well as in the accompanying drawings.

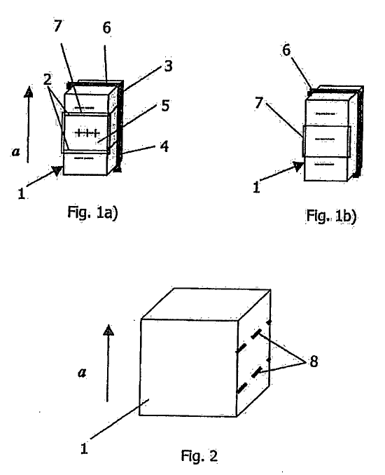

FIG. 1a shows thereby schematically a crystal of the device according to the invention together with a surrounding magnetic coil in a three-domain-state; FIG. 1b shows the crystal of FIG. 1a in a monodomain state after applying a magnetic field pulse with negative polarity;

FIG. 2 shows an advantageous embodiment of the crystal for the device according the invention with a schematic illustration of inhomogeneities for local stabilization of the domains.

The crystal 1 of the inventive device illustrated in the drawings consists exemplarily of yttrium orthoferrite or similar magnetic uniaxial material. The crystal is cut perpendicular to the optical axis for a predetermined wave length. The optical axes for yttrium orthoferrite lie in the crystallographic bc-plane and they form an angle with the c-axis of 47 degrees for light wavelengths of 1.3 μm. The necessary thickness for said wavelength is 1.1 mm to enable rotation of the polarization plane by 45 degrees whereby the height of the crystal is 1.2 mm.

The crystal 1 is initially in a state of having three magnetic domains 3, 4, 5 without having an outer magnetic field. The domain walls 2 of such a crystal 1 border one another and they are oriented in an opposite way relative to the magnetized domains 3, 4, 5 and perpendicular to the crystallographic a-axis (see FIG. 1a). The height of the upper and lower domains 3, 4 measures approximately 300 to 350 μm, whereby said domains are negatively magnetized in the shown example of FIG. 1a, and whereby the center domain is, in contrast, positively magnetized and has a height of approximately 500 μm, possibly even a little more.

The crystal 1 is magnetized up to the reversible monodomain state while applying a magnetic field pulse of negative polarity with a magnetic field intensity H1 by means of a coil 6 surrounding the entire crystal 1, which is illustrated in FIG. 1b. The coil 6 is illustrated only schematically in FIG. 1a and 1b and it is actually higher or thicker than the crystal 1. For example, the coil has a height of approximately 1.5 mm for a crystal 1 of 1.2 mm in height.

The monodomain state in the crystal is not completely ended after its initiation based on the applied magnetic field pulse but its initial magnetic field intensity H1 is merely taken back to a retention magnetic field intensity H2 produced by the coil 6, which is now maximal one third of the magnetic field intensity H1. Completeness is most often reached with retention field intensities H2 of maximal 10 percent of the magnetic field intensity H1. The monodomain state of FIG. 1b is maintained through this retention magnetic field H2 with very low energy consumption and magnetization change of the central domain 5 into the initial orientation (FIG. 1a) is prevented thereby.

The decrease of magnetic field intensity to zero through terminating the electric supply to the coil 6 permits then the return by the crystal into the multidomain state shown in FIG. 1a with positive magnetization of the central domains 5. This state can again be maintained without any external energy supply. However, the transition back to this state occurs very slowly without external energy supply, which means in the microsecond range. A local positive magnetic field pulse Hloc can be applied locally to the central domain 5 to accelerate this return to improve the switching times of the device, whereby said local positive magnetic field pulse Hloc only effects the rapid magnetization change of the central domain into the positive value. For example, this can be realized through a second magnetic coil 7 surrounding or contacting the central domain 5, which has the additional advantage that the negative magnetized domains 3, 4 are not negatively influenced outside the coil 7.

On the other hand, a positive magnetic field pulse acting upon the entire crystal 1 would cause a long-lasting change in magnetization to positive values for the entire crystal—at the respective magnetic field intensity—so that very high coercive forces have to be overcome each time for subsequent changes in magnetization.

The retention magnetic field H2 can be created possibly by a permanent magnet on or next to the crystal 1 in stead of the coil 6, whereby the magnetic field source producing the magnetic field pulse with the magnetic field intensity H1 can be completely turned off and the crystal 1 can be kept in the changed magnetized state of FIG. 1 without any external energy supply.

Inhomogeneities (non-homogeneities) 8 can be again used on the crystal 1 for local stabilization of the domains 3, 4, 5. These inhomogeneities 8, e.g. crevices, scratches or the like, are placed on the surface of the crystal 1, possibly on the side(s) of the crystal 1, as shown in FIG. 2. The direction of the crevices or scratches 8 is perpendicular to the crystallographic a-axis and parallel to the planes of the walls 2 of the domains 3, 4, 5.

Should light beams be guided now through the central domain 5, then the polarization of light is changed depending on the type of magnetization and it can be switched rapidly thereby.

1. A method for modifying the polarization state of light with a magnetic uniaxial crystal which initially has a specific multidomain structure wherein light enters through predefined areas of the crystal, wherein a magnetic field pulse having a magnetic intensity H1 is applied to the crystal (1) and wherein the crystal (1) is transformed into a reversible monodomain state, characterized in that a retention magnetic field of the same polarity and having a magnetic field intensity H2 is applied to the crystal (1) after transition of the crystal (1) into a reversible monodomain state, wherein the magnetic intensity H2 is lower than the magnetic field intensity H1 and the reversible monodomain state is maintained.

2. A method according to claim 1, wherein the retention magnetic field H2 is adjusted by changing the magnetic field intensity of the previously applied magnetic field pulse.

3. A method according to claim 1, wherein the crystal (1) having a retention magnetic field of the magnetic field intensity H2 and the same polarity as the one with the magnetic field pulse is permanently biased with the magnetic field intensity H1.

4. A method according to claim 1, wherein the magnetic field intensity H2 of the retention magnetic field is maximal one third of the magnetic field intensity H1 of the magnetic field pulse, preferably maximal 10 percent of said magnetic field intensity H1, which is required to reach the reversible monodomain state of the crystal (1).

5. A method according to claim 1, wherein at least at one area (5) of the crystal (1)—which has been reversibly changed in polarization—a magnetic field is applied with a polarity opposite to the reversible re-polarized magnetic field pulse until the initial polarization of the crystal (1) has been re-established in this area (5).

6. A method according to claim 1, wherein domain walls (2) are kept in predetermined positions by inhomogeneities (6) created in the crystal (1).

7. A method according to claim 1, wherein light beams are guided through areas in the crystal (1) which are changed in polarization by applying the magnetic field pulse with the magnet field intensity H1.

8. A device for modifying the polarization state of light claim 1, comprising a magneto-optical rotator formed by a magnetic uniaxial crystal (1) which has initially a specific multidomain structure and at least one device to produce magnetic field pulses and apply them to the crystal (1), and it comprises at least one controllable source for the magnetic field pulses and a control switch for the magnetic field source, characterized in that the device is designed for the creation of magnetic fields of at least two different magnetic field intensities H1 and H2.

9. A device according to claim 8, whereby the control switch of the controllable magnetic field source is provided with at least two switching conditions controlling the magnetic field source for the creation of magnetic fields or magnetic field pulses of different magnetic field intensities H1 and H2.

10. A device according to claim 8, whereby the device to create and apply magnetic fields on the crystal (1) is provided with a controllable magnetic field source having at least two switching conditions and a permanent magnetic field source, and whereby the controllable magnetic source supplies in one switching condition a considerably higher magnetic field intensity H1 than the magnetic field intensity H2 of the permanent magnetic field source.

11. A device according to claim 8, whereby an additional controllable magnetic field source is provided effecting only one area (5) of the crystal (1) with a magnetic field or magnetic field pulses, whereby said area corresponds to the domains (5) re-polarized by the magnetic field pulses of the first magnetic field source, and whereby the polarity of the additional controllable magnetic field source is opposite the polarity of the magnetic fields or pulses having magnetic field intensities H1 and H2.

12. A device according to claim 8, whereby the crystal (1) is provided with inhomogeneities (8) fixing the domains (3, 4, 5) in predetermined positions and whereby said inhomogeneities (8) are located preferably on the sides of the crystal (1).
